(19) United States
(12) Patent Application Publication
(10) Pub. No.: US 2022/0167051 A1
(43) Pub. Date: May 26, 2022

(54) AUTOMATIC CLASSIFICATION OF HOUSEHOLDS BASED ON CONTENT CONSUMPTION

(71) Applicant: Xandr Inc., New York, NY (US)

(72) Inventors: Elijah Hall, Plano, TX (US); Todd Bocksell, Chicago, IL (US); Eun Pyung Park, Seattle, WA (US); Peter Willard Shankel, Sachse, TX (US); Matthew Robert Teshera, Weehawken, NJ (US); Christopher A. Sitton, Rockwall, TX (US)

(73) Assignee: Xandr Inc., New York, NY (US)

(21) Appl. No.: 17/100,375

(22) Filed: Nov. 20, 2020

(51) Int. Cl. H04N 21/466; H04N 21/458

(52) U.S. Cl. CPC H04N 21/4661; G06K 9/6259; H04N 21/458

(57) ABSTRACT

Aspects of the subject disclosure may include, for example, receiving viewership data for a plurality of devices associated with a household, the devices for viewing content items received over a network from a network provider at the household, concatenating respective viewership data for respective devices of the plurality of devices, forming respective device documents, vectorizing the respective device documents to form vectorized device documents, concatenating the vectorized device documents to form a household corpus of viewership data for the household, training a clustering model on the household corpus of viewership data to form a household topological fingerprint (HTF) for the household, the HTF forming a vector classification of viewership patterns for the household, and selecting content items for the household based on the HTF. Other embodiments are disclosed.

### FIELD OF THE DISCLOSURE

The subject disclosure relates to a system and method for automatically classification of households based on content consumption.

### BACKGROUND

There is a need to identify viewers of content items on various devices within a household. Identity has various levels of granularity, including household, device and individual. It is known to collect set-top box information for a household to develop an understanding of what content has been viewed by members of the household, and draw inferences therefrom.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B shows a plot of the perplexity curve and slope of the perplexity curve for the LDA model of FIG. 2A in accordance with various aspects described herein.

FIG. 2C shows a sample of six of an exemplary set of 30 topics for the LDA model of FIG. 2A in accordance with various aspects described herein.

FIG. 2D illustrates an exemplary embodiment of a model for a device topological signature in accordance with various aspects described herein.

FIG. 2E depicts an illustrative embodiment of a method in accordance with various aspects described herein.

FIG. 2F is a block diagram illustrating an example, non-limiting embodiment of a system 270 functioning within the communication network of FIG. 1 in accordance with various aspects described herein.

FIG. 2G is a block diagram of an exemplary inference trait model pipeline 290 in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for collecting content viewership information for a household and processing the information to develop a household topological fingerprint for the household. A household may be defined as any group of content consumers, connected in some fashion. One example is a residence or other premises and the persons that reside therein. Another example is a family with members residing at a variety of locations, including a primary residence, a summer home, children away at school, etc. The members of the household consume content, which may include television programming, video content, images, music and data. The content may be communicated to the content consumers in any suitable fashion, by broadcast, by cable network, by wireline and wireless communication including the internet. In one aspect, a household may be defined by content consumers who share one or more accounts with a network operator such as a cable television provider or a satellite television provider, and/or one or more accounts with a content provider such as an online video provider or music provider. The shared account provides one method for the members to be grouped and monitor and handled together.

The household topological fingerprint forms a vector classification of the content and television viewing patterns recorded for a household across topics from an unsupervised latent Dirichlet allocation clustering model. The household topological fingerprint contains a compact representation of the content viewing patterns of the household held in viewership datasets. The household topological fingerprint may be used to select content items including advertising for the household and for other purposes. Other embodiments are described in the subject disclosure.

One or more aspects of the subject disclosure include receiving viewership data for a plurality of devices associated with a household, wherein the devices are for viewing content items received over a network from a network provider at the household and concatenating respective viewership data for respective devices of the plurality of devices. The subject disclosure further includes forming respective device documents, vectorizing the respective device documents to form vectorized device documents, and concatenating the vectorized device documents to form a household corpus of viewership data for the household. The subject disclosure further includes training a clustering model on the household corpus of viewership data to form a household topological fingerprint (HTF) for the household, the HTF forming a vector classification of viewership patterns for the household, and selecting content items for the household based on the HTF.

One or more aspects of the subject disclosure include receiving content viewership data for content items viewed by members of a household, filtering the content viewership data to remove irregular data, forming filtered viewership data and combining the filtered viewership data for respective viewing devices of the household according to respective device identifiers of the respective viewing devices, forming device documents. The subject disclosure further includes combining the device documents for the respective viewing devices of the household to form a household corpus of viewership data for the household, training a clustering mode on the household corpus of viewership data, forming a household topological fingerprint (HTF) for the household, the HTF forming a vector classification of viewership patterns for the household, associating respective members of the household with the respective viewing devices of the household, and selecting content items for the respective members of the household based on the HTF.

One or more aspects of the subject disclosure include receiving television viewership data for content items viewed by members of a household, the television viewership data including text string information, filtering the television viewership data to remove irregular data, forming filtered television viewership data, and concatenating text string information of the filtered television viewership data, wherein the concatenating text string information is based on device identifiers associated with viewing devices of the household, forming device documents for respective device of the household. The subject disclosure further includes concatenating the device documents, forming a household corpus of viewership data for the household, forming a vector classification of viewership patterns for the household, wherein the forming the vector classification comprises training a clustering model on the household corpus of viewership data, identifying the members of the household by applying a portion of the device documents to the clustering model, and selecting content items for viewing by respective members of the household based on the identifying the members of the household and the vector classification.

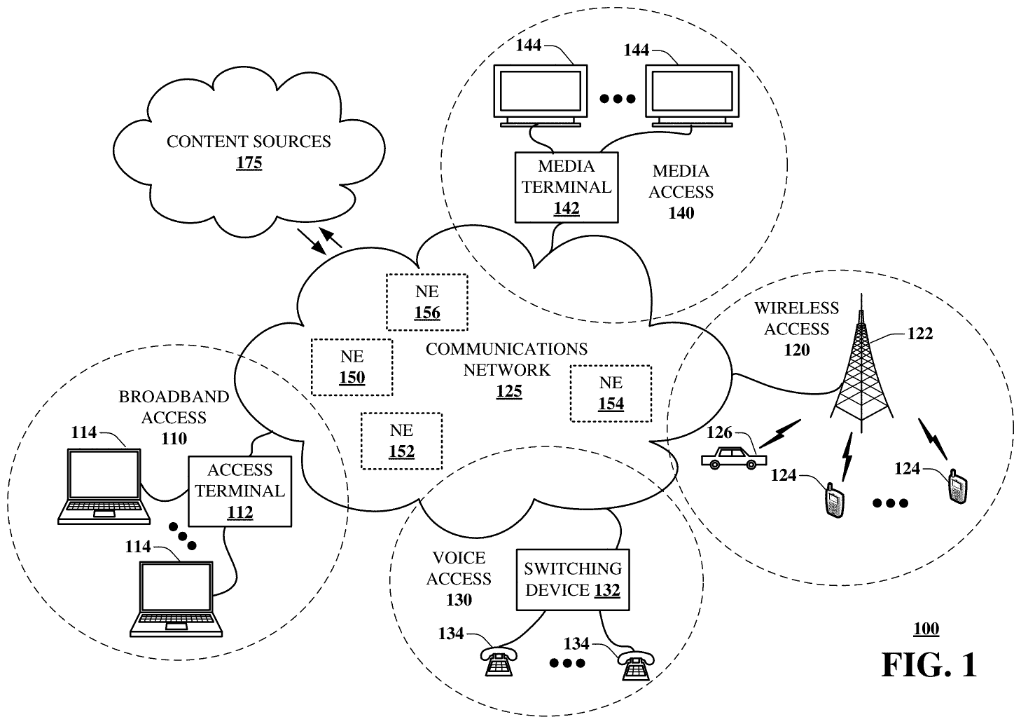

Referring now to FIG. 1, a block diagram is shown illustrating an example, non-limiting embodiment of a system 100 in accordance with various aspects described herein. For example, system 100 can facilitate in whole or in part receiving content viewership data for content items viewed by members of a household, developing a household topological fingerprint for the household, and using the household topological fingerprint to provide additional content items including advertising to the household. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

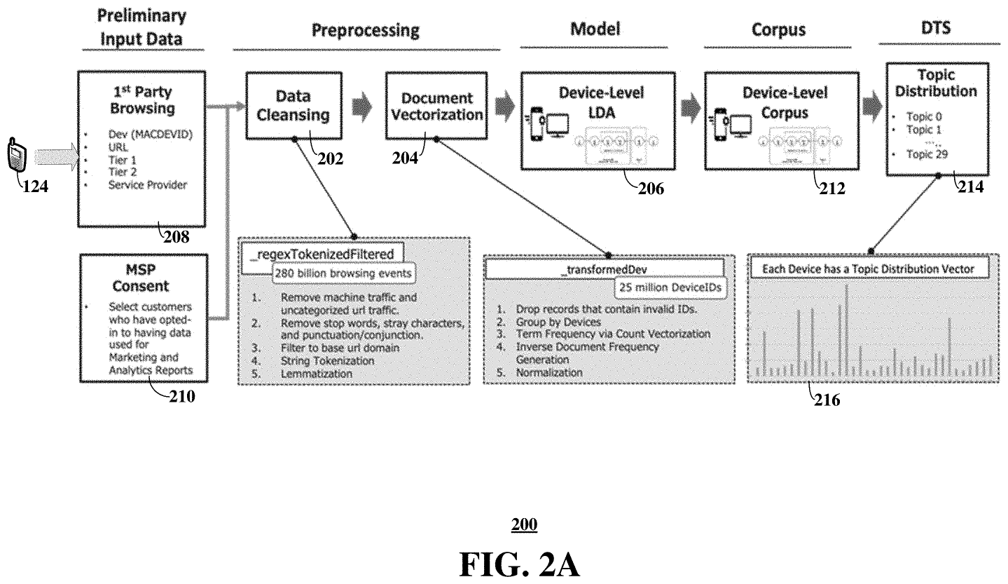

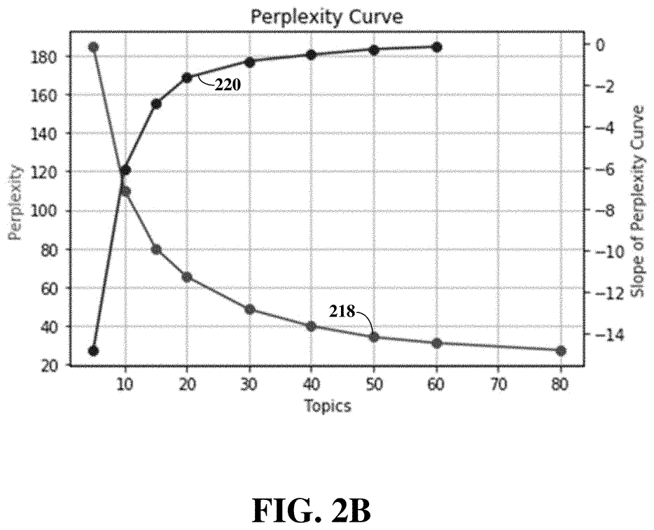

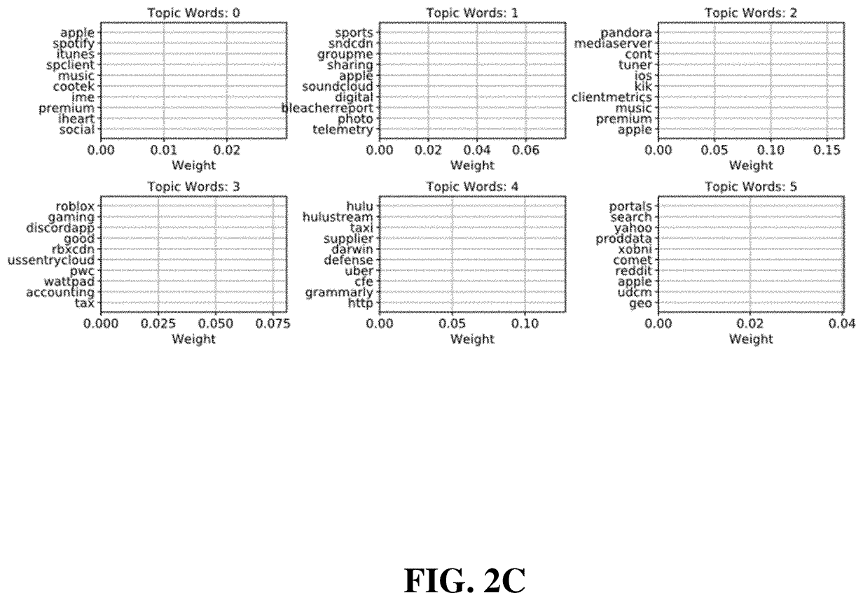

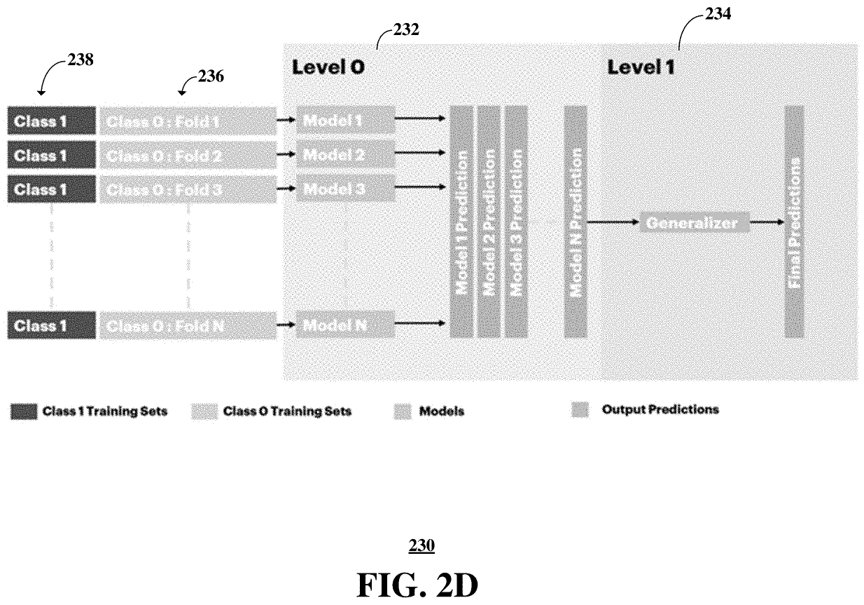

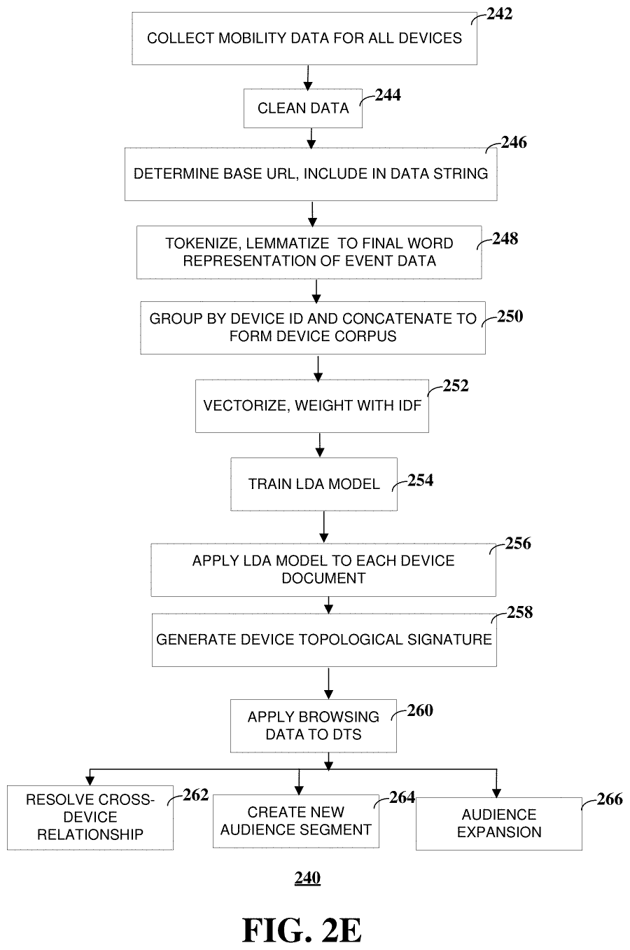

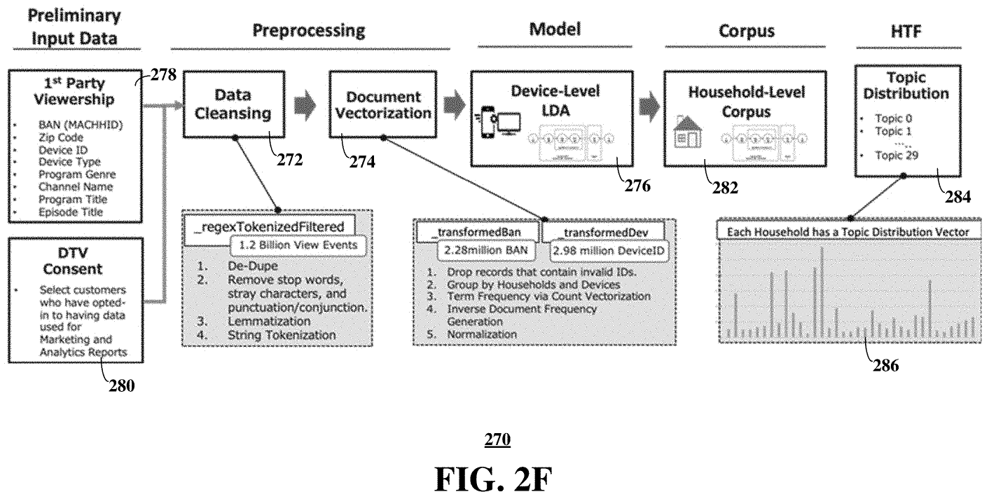

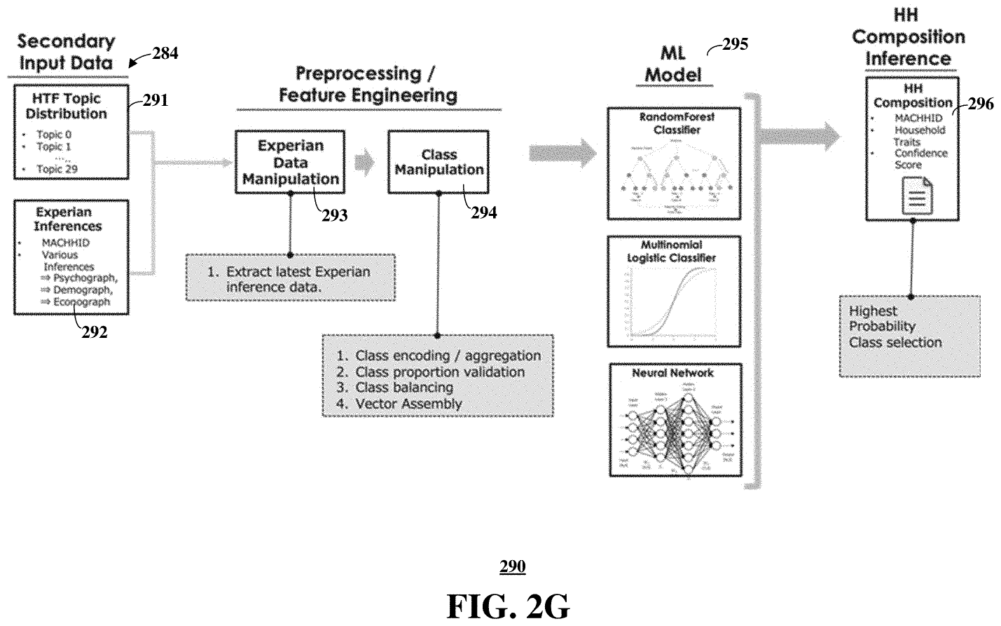

FIG. 2A is a block diagram illustrating an example, non-limiting embodiment of a system 200 functioning within the communication network of FIG. 1 in accordance with various aspects described herein. The system 200 may be used to identify different devices used by different individuals of a household based on activity of the devices. A household may be defined as any group of content consumers, connected in some fashion. One example is a residence or other premises and the persons that reside therein. Another example is a family with members residing at a variety of locations, including a primary residence, a summer home, children away at school, etc. The members of the household consume content, which may include television programming, video content, images, music and data. The content may be communicated to the content consumers in any suitable fashion, by broadcast, by cable network, by wireline and wireless communication including the internet. In one aspect, a household may be defined by content consumers who share one or more accounts with a network operator such as a cable television provider or a satellite television provider, and/or one or more accounts with a content provider such as an online video provider or music provider. The shared account provides one method for the members to be grouped and monitor and handled together.

The system 200 presents an identity model to develop a probabilistic methodology for identity resolution for an operator of telecommunication networks, multimedia networks and other data communication networks. The system 200 develops a device topological signature for a mobile device such as mobile device 124 of FIG. 1. The device topological signature may be used for identity resolution for mobile devices and users of mobile devices. The device topological signature may further be used to identify interests of the users of the mobile devices, for example, for targeting advertising to the users.

A data communication network may be operated by a network operator to provide data communication services to subscribers and other users of the network. Examples of data communication networks include cellular networks such as wireless access 120, media access 140 and broadband access 110 of FIG. 1. Other examples may be envisioned as well. One network operator may operate multiple networks, such as a wireless access network for voice and data communication along with a broadband access network and a media access network for viewing media content. A subscriber may have accounts for network access on more than one such network. A subscriber may have multiple devices operable on one or more networks, such as mobile telephones, tablet computers, etc., and home devices such as a set top box (STB), digital video recorder (DVR), laptop and other computers, and a home gateway that are all associated with a household or other premises. Multiple subscribers, such as multiple family members, and their multiple devices, may together be associated with the household. There is a need to identify devices and subscribers and households to understand usage of various data communication networks.

A network operator may collect substantial data about subscribers based on usage of subscriber equipment. For example, one network operator has 58 million wireless network subscribers and 10 million pay television subscribers. Such subscribers generate substantial subscriber usage data during use of subscriber equipment. Such subscriber usage data includes mobile browsing data. For example, each network search or website access generates Uniform Resource Locator (URL) data and other information. Many user devices are equipped with applications (apps) that access data from other sources and generate additional subscriber usage data. Further, mobile devices that include voice service, such as a mobile telephone, generate additional subscriber usage data in the form of incoming and outgoing calls associated with calling numbers and called numbers, respectively.

Similarly, a network operator of a media distribution network has access to substantial subscriber usage data. Such a media distribution network may include, for example, a satellite television network, a cable television network, or delivery of media including television programming using Internet Protocol Television (IPTV) or over the top (OTT) media delivery to a premises. Subscribers generate subscriber usage data including information about channels viewed, programs watched, duration of viewing, etc. Subscribers with internet access generate large amounts of home (or other premises) browsing data, which is similar to mobile browsing data from mobile devices. Further, cookie data is generated by browsing devices which may be observed and collected as well. A network operator who operates both a wireless access network and a media distribution network has access to very large amounts of subscriber usage data, such as peta-bytes of data per day. Such subscriber usage data may be used to identify and learn more about subscribers, devices and households.

An identity in a data communication network may be defined with varying levels of granularity. The granularities of identity may include, for example, household, device, and individual. That is, a household may be identified by and associated with one or more devices and one or more individuals. An individual may be identified by and associated with one or more devices. Conventionally, it is known to use a deterministic methodology for identity resolution to match a device to a household by mapping internet protocol (IP) addresses of registered device location information, device identification information extracted from native applications operating on the device, and information that is associated with device identifiers that originate from devices to first party data points retained by the network operator. However, in some networks, a very large amount of subscriber usage data prevents realistic use of the deterministic methodology for identity resolution. A rule-based system coded by human design cannot adequately pair individuals of a household to devices, much less complete its computation within a polynomial time. Sheer volume of feature datasets, the need to use free-texted characters (e.g. viewership program names or full channel names) as features targeted for analysis, and combinatorial permutations of those features for each of millions of household accounts are impossibly complex to compute with systemized business rules alone.

Instead, what is needed is a lightweight, quick, computationally reasonable tool for identifying a unique signature of a particular device, such as over a particular time period. This tool may be referred to as a Device Topological Signature (DTS). Even among devices that have similar browsing patterns, individuals that are associated with the devices can be uniquely identified using the DTS with high reliability. Individuals can be identified based on the devices they use. Moreover, such information can be used for identifying interests of individuals including media interests for purposes such as audience expansion. An individual can be associated with an audience based on interests perceived by subscriber usage data. Based on the DTS and cookie data, a graph may be developed for a household so that a cookie may be associated with a device and an individual within a household. Similarly, cross-device resolution can be done across mobile devices and laptop computers or other devices within a household based on similar DTS. This enables cross-device linking which in turn enables cross-screen advertising, and other features. Use of a DTS enables identifying and targeting an individual, at the person level, across the person's three primary screens, including a mobile device screen, a television screen viewing broadcast or cable television and on a screen for a pay television service such as broadcast satellite television. Use of DTS enables a probabilistic matching process to link devices within a household.

The DTS is the vector classification of the browsing patterns recorded for each device across the topics from an unsupervised latent Dirichlet allocation (LDA) clustering. The DTS topic vector is the distribution of that device for each of the topics such that the sum of the DTS topic vector components is 1. The process quantifies a high-volume mobile network operator data pattern into a fingerprint descriptor that is unique to each device, and can be used as features for probabilistic Identity Resolution (IDR) exercises.

In exemplary embodiments, DTS is a vector classification derived from a mobile network operator's data logs that were collected as smartphone mobile browsing patterns. Those datasets are augmented, then provided to an algorithm that categorizes each mobile device's browsing signals to a pre-configured number of topics that are created from an unsupervised LDA clustering algorithm. This DTS data is then used to build machine learning models to discover links between devices with similar DTSs and a measure of the strength of that similarity. The DTS data is also used as a feature for other machine learning models for segmentation and audience expansion, or to predict demographic, econographic, or psychographic information for the device user.

In general, in an exemplary embodiment, data corresponding to internet traffic, including, browsing data is collected for a device such as a mobile device. A set of filtering and augmentation operations to produce a unique browsing pattern representing activity for the mobile device. An LDA algorithm may be then applied to provide clustering and reveal the unique characteristics of the DTS. Those unique characteristics can be used for comparison to quantify each specific device according to those patterns.

Various ad insertion management techniques and/or devices can be utilized in conjunction with the embodiments described herein (e.g., line items, deals, auctions, business rule enforcement, yield policy enforcement, competitive separation enforcement, and others) such as described in U.S. patent application Ser. No. 16/560,666 filed Sep. 4, 2019 and entitled Content Management in Over-The-Top Services, and also described in U.S. application Ser. No. 16/870,098 filed May 8, 2020 and entitled “Method and Apparatus for Managing Deals of Brokers in Electronic Advertising”, the disclosures of which are hereby incorporated by reference herein in their entirety.

The system 200 of FIG. 2A is adapted for developing a DTS for a device or a user. The device may be a mobile device of a user such as mobile device 124 (FIG. 1), including a mobile phone, a tablet or other device. In some examples, the device may be laptop or other computer of a user. The system 200 in the exemplary embodiment includes a data cleansing module 202, a document vectorization module 204, and an LDA model 206. Other embodiments may include other components as well, or alternative components. The system 200 may be implemented on a device itself, such as a mobile phone, tablet, personal computer, set top box, internet gateway, or other source or channel of data. Also, the system 200 may be implemented on a separate device such as a server or other data processing system with access to data viewed by, received by or communicated from a device for which the DTS is desired.

The data cleansing module 202 and the document vectorization module 204 form a preprocessing module for preprocessing the input data 208. Preprocessing the input data 208 includes removing irregular data and formatting data into a standardized format. The data cleansing module 202 receives input data 208. The input data 208 may include any suitable data available at the device 124. Generally, the input data 208 includes browsing data obtained from the device 124. In the illustrated example in which the device for which the DTS is desired performs online browsing, the input data 208 may include a device identifier such as a Mac device identifier for an Apple® Mac computer. The device identifier may be used for uniquely identifying the device and the DTS that is developed.

The input data 208 may further include browsing data produced when a user or operator of the device 124 accesses information over networks including the internet. In one embodiment, the input data 208 includes mobility data for all devices and contains all of the human and machine related traffic for each device. The input data may be recorded as Uniform Resource Locator (URL), IAB codes from the Interactive Advertising Bureau (IAB) such as an IAB tier1 code, and an IAB tier 2 code for each device where Anova or another source provides the codes for tier 1 and tier 2, along with descriptions of those categories. The browsing data may further include information such as a Uniform Resource Locator (URL) of a web page or other document accessed by the device. The browsing data may further include Tier 1 and Tier 2 browsing data. Generally, Tier 1 browsing data is data generated by operation of a Tier 1 browser and Tier 2 browsing data is data generated by operation of a Tier 2 browser. Other data and types of data may be included as well. Still further, the input data may include information about one or more service providers providing network access, such as a mobile network operator, or a search service provider.

Generally, any data produced during operation of the device may be collected and analyzed as input data 208 to the data cleansing module 202. In particular embodiments, certain data elements are of interest. A first data element of interest is timestamp data, corresponding to the data and time the browsing data was collected. Time stamp information may include or be supplemented with geographical information such as Global Positioning System (GPS) coordinates or address information. A second data element of interest is a Mobile Station International Subscriber Directory Number or MSISDN for the device, which corresponds to a number uniquely identifying a subscription in a Global System for Mobile (GSM) communications network or a Universal Mobile Telecommunications System (UMTS) mobile network. The MSISDN is the mapping of the telephone number to the subscriber identity module in a mobile or cellular phone. A third data element of particular interest is the Uniform Resource Locator or URL of a page or document accessed by the device. A fourth and a fifth data element of particular interest are identifiers for a Tier 1 and Tier 2 service provider, or tier1_id, tier2_id. A sixth data element of particular interest is a Service Provider Identifier or service_provider_id. This data may originate with or be provided by in whole or in part by a Managed Service Provider (MSP) or other organization that delivers services such as network services, application services, infrastructure services and security services for another service provider such as a mobile network operator. Other data may be received or accessed and used as well.

In some embodiments, a consent module 210 obtains consent of user involved in the collection, processing and use of data by the system 200. For example, some users associated with devices such as mobile phones or home gateways or set-top boxes may be given the opportunity to voluntarily opt-in or opt-out of services which may access and make use of data of the user. Such consent may pertain to use of user data for marketing, analytics and other network functions. Only if user consent has been obtained is the user's data accessed by the data cleansing module 202 and other features of the system 200.

In some embodiments, the input data 208 may be segmented or limited to provide certain capabilities or insights. As indicated, the quantity of input data 208 may be very large, even for just a single user or device or household. In FIG. 2A, the tokenized and filtered data may correspond to 280 billion browsing events in one example. Accordingly, the input data 208 may be filtered according to geographical information or time stamp information so that only activities occurring within a defined area or time are considered and further processed. This operates to limit the amount of data that must be processed and the amount of time required for processing data, and may allow further data processing to be completed on smaller or simpler computer equipment, i.e., without large data storage capability. Further, in order to assist with grouping users or devices together, such as according to a household, the data may be filtered according to location or time or both. Thus, two devices storing matching location and time stamp information over an extended period or over a series of periods may be part of the same household.

The data cleansing module 202 operates in some embodiments to remove certain data from the input data 208. The output produced by the data cleansing module 202 may be a data string of concatenated input data after cleansing. In one embodiment, the input data 208 is cleaned by filtering out the tier1 and tier2 events that are related to non-human activity or are uncategorized. Next, punctuation, stray characters, and stop words are removed, and the base URL domain is determined and included in the data string. Finally, the string is tokenized and lemmatized into the final word representation of the event data. Other processes or alternative processes may be used for processing the data.

The data cleansing module 202 may operate to remove, for example, certain internet service provider (ISP) data and machine-to-machine data in order to focus on specific patterns of data that are directly attributed to user behavior. For example, in some embodiments, the input data 208 including browsing data may contain a large quantity of machine-related traffic that should be filtered out to arrive at human-initiated browsing activity. This is accomplished by filtering out the tier1 and tier2 events that are related to non-human activity or are uncategorized. Further, punctuation, stray characters, and stop words may be removed along with any punctuation and words that merely conjoin sentence fragments such as conjunctions or disjunctions. The base URL domain may be determined and included in the data string. Finally, the data string is tokenized and lemmatized into the final word representation of the event data. Tokenization is a process of demarcating and classifying a string of input characters. Lemmatizing is a process of locating a base or root of a work. Other processes may be performed as well, such as natural language text processing like canonicalization of input data. One goal is to be able to quantify and to classify the behavior of the user based on the input data originating with the user.

The document vectorization module 204 receives from the data cleansing module 202 the data string of concatenated input data after cleansing. The document vectorization module 204 produces a device corpus. The device corpus may obtained in an exemplary embodiment by dropping events with invalid device ids and then grouping by device id and concatenate all the event strings together, so each device has a browsing document and these documents together comprise the device corpus. The documents are vectorized and weighted with inverse document frequency (IDF) count.

In exemplary embodiments, the document vectorization module 204 produces the device corpus by first filtering or omitting events with invalid device identifiers. For example, the system 200 may maintain a list of valid device identifiers and filter events from the data string which have a device identifier that is not on the list of valid identifiers. Further, the document vectorization module 204 may group together data of the data string based on device identifier so that all events having a common device identifier are grouped together. Still further, the document vectorization module 204 may concatenate all the event strings together, so that each device has an associated browsing document. These documents together form the device corpus. In some embodiments, the respective device documents may be vectorized. A vectorizer operates to convert a collection of text documents to vectors of token counts. For example, the vectorization module 204 may select a predetermined number of words ordered by term frequency across the corpus. The result is sparse representations of the events over the vocabulary of the vectorizer. These sparse representations can then be passed to other processes. An example vectorizer is the CountVectorizer in Python that is part of the Apache Spark set of tools. Further, the vectorized documents may be further processed in any suitable way. In the example embodiment, the documents are weighted using and inverse document frequency (IDF) count. The vectorized output may be further normalized to facilitate data processing. As indicated in FIG. 2A, the vectorized output of the document vectorization module 204 may correspond to 25 million device identifiers, in one example. The vectorized output of the document vectorization module 204 is represented in FIG. 2A as device-level corpus 212.

The vectorized output of the document vectorization module 204 is provided to the LDA model 206. The LDA model 206 in an embodiment implements an unsupervised latent Dirichlet allocation (LDA) clustering model. The LDA model 206 is trained on the entire vectorized device-level corpus 212 received from the document vectorization module 204. In an exemplary embodiment, the training is done using, in this example, 30 topics. The LDA model 206 is applied to each device document to arrive at the device topological signature (DTS) 214.

The LDA model 206 is the algorithm that is used to arrive at the DTS 214 for the device. Once the DTS 214 for a device is available, the DTS 214 can be used in subsequent models such as machine learning models. The DTS 214 contains substantially all distinguishing and important details for the device. The DTS 214 is a succinct and compact representation of a subscriber's behavior on the device. To develop a further predictive model to predict some other attribute for the subscriber, the DTS 214 may be used as an input into the model instead of consuming the entire history of the subscriber's browsing activity. The DTS 214 is a representation of the subscriber's browsing activity. Its compact size allows computational efficiency during subsequent use.

The LDA model 206 provides the definition for 30 different topics. Each topic is a unique, distinctive unit. Once the 30 topics are defined, the entire signal for each device is evaluated for its distribution among the 30 topics. The result is a vector representing the distribution among the 30 topics. That is the DTS for the device. LDA looks at words and topics in the input data and creates a clustering or grouping based on the terms it finds. The system 200 provides to the LDA model 206 web site categorization in a standardized word format, with some other traits, and lets the LDA model 206 determine how topics of the device's browsing history are clustered. The LDA model 206 processes words such as URL information and arrives at the topics that are distinct among the data set. The topics can be applied to the input data for each set to learn the distribution of the topics for the device. That corresponds to a unique representation for each device.

One of the parameters for an LDA model is the number of topics. In some embodiments, the number of topics may be received as a user input to control the number of topics used for the LDA model. Perplexity is a statistic from information theory that measures how well a model predicts a sample. The smaller the perplexity the more accurate the prediction is and is frequently used to evaluate language models in natural language processing. For an LDA model such as LDA model 206, the perplexity curve and slope of the perplexity curve provide guidance on the number of topics appropriate for the problem. Increasing the number of topics in general will result in a smaller perplexity and plotting the perplexity and perplexity slope versus the number of topics shows the incremental improvement in model prediction from increasing the number of topics.

FIG. 2B shows a plot of the perplexity curve 218 and slope of the perplexity curve 220 for the LDA model, in accordance with various aspects described herein, with number of topics ranging from 5 to 80. From FIG. 2B, perplexity as represented by the perplexity curve 218 decreases quickly as the number of topics increases initially and the rate of decreasing perplexity (slope of the perplexity curve 220) slows down as the number of topics increases. From the figure, 30 topics was empirically selected as the number of topics to use for the LDA model 206 (FIG. 2A) since increasing the number of topics increases the computational time but there is not a significant increase in the model prediction after 30 topics. Thus, the number of topics for the LDA model 206 may be chosen to provide suitable prediction accuracy for the particular embodiment while reducing computational time and complexity for the particular embodiment. In other examples, other numbers of topics could be chosen.

The specific topics are chosen each time the LDA model is trained. Over time, as browsing data changes to reflect varying users and user interests, the specific topics will vary as well. The LDA model 206 classifies each user device such as a mobile phone according to the 30 topics. In addition, the LDA model 206 may be used as a unique signature for that device. A topic may include a collection of words that the LDA model 206 has selected because they are related and are consistently used together and distinct from other topic. The words together form a topic. The model is unsupervised, meaning that the model is not prompted, by human invention or otherwise, with what the topics are. Individual respective words of the topic have a respective weight associated with the word, and the highest-weighted words tend to best describe the topic. The LDA model operates to classify every word from the input data into a topic, in effect forming an array of words that best describe a topic. The highest-weighted words best describe a single topic. The weights can change over time, so the descriptions can change over time based on traffic or the subject of browsing by users on their devices. The weighting is based on frequency at which certain words are seen together. FIG. 2C shows a sample of six of an exemplary set of 30 topics for the LDA model 206 of FIG. 2A in accordance with various aspects described herein. The example of FIG. 2C shows the top 10 words in each topic sorted by the importance of each word.

The DTS 214 is a compact representation of human browsing activity on a user device such as a mobile telephone. Each DTS has a topic distribution vector 216, as illustrated in FIG. 2A. The DTS 214 is a vector of dimension 30 in a normed vector space and the 30 topics from the LDA training are a basis for this vector space, thus allowing for efficient distance and similarity measures. This benefits segmentation and machine learning models by providing a feature with well-behaved and strictly numeric properties.

The DTS 214 can be used in a variety of ways. In a first example, the DTS 214 is used to resolve cross-device relationships. A network operator or content provider or advertiser may have information about data sent to devices including mobile devices such as device 124 and stationary devices in a household. However, it is more difficult to know which individual user is using such a device and to associate the usage with both the device and the user. A household of even just two individuals may include three or more computers, three or more mobile telephones, and two or more tablet computers, and so forth. Further, such a household may have 3 or more television sets plus a home gateway, a digital video recorder (DVR) and other devices as well. If a network operator or content provider or advertiser wants to target one particular individual of the household, the individual who is using each device should be identified. Being able to associate individual users with respective devices, and the content the users consume, has the highest value to parties such as the network operator, the content provider and the advertiser. For example, if these parties can send a sequence of advertisements or a plurality of advertisements to multiple devices, so that the user sees multiple ads in a short amount of time, the advertising will be more effective at capturing the user's attention and persuading the user as intended, such as to make a purchase. The DTS 214 may be used to identify a user who is using a particular device in a household and to distinguish respective users based on the signature provided by their respective DTS.

In a second example, the DTS 214 is used to create organic segments based on the DTS 214. Segments are individuals or groups within a population that have some common interest or feature that suggests they should be combined in a group to, for example, receive the same television programming or advertising. Certain individuals have lifestyle preferences such as sports enthusiasts. Within a group of sports enthusiasts, there are sub-groups of golf enthusiasts and basketball enthusiasts, and enthusiasts for basketball and baseball together. There are other groupings and combinations. Other people have related interests that may be matched with the interests of individuals based on DTS 214. People have political preferences, such as an interest in news but only liberal news or conservative news. The DTS 214 can be used to detect those interests among viewers or users of devices. Subsequently, the user associated with the DTS 214 may be included in a segment of sports enthusiasts or liberal news enthusiasts and that segment may be used for targeting advertising or content. That is, if an advertiser or content provider wishes to display advertising or other content to viewers in the segment of sports enthusiasts, for example, the advertiser or content provider can specify that segment and the advertising or content will be provided to one or more of the devices associated with the user.

In a third example, the DTS 214 is used to facilitate audience expansion. If a network operator or content provider has a substantial amount of data on users of devices such as mobile devices and home devices, that network operator or content provider may create look-alike audience models based on the existing users. For example, the operator may have a relatively large amount of data on a relatively few number of people. If an advertiser wishes to target users based on properties such as demographics or interests, the advertiser can specify one or more audience segments having those characteristics. However, the target segments may be too narrow, for example, and have relatively few users as members of the target segments. An option is to use look-alike audience modelling to identify or create a segment that includes users similar to users in a given user segment. Because of the volume of user data, the look-alike models may be very granular in nature, meaning they are focused on very narrow interests or preferences of viewers. The DTS 214 enables determining a look-alike model in a substantially reduced amount of time, using substantially reduced computer resources. The DTS 214 is a representation of all of a user's mobile browsing. Therefore, using the 30 topics with the DTS, a look-alike model may be developed in, for example, 20-30 minutes of processing time in contrast with 20-30 hours of processing time to identify a look-alike model using all of the device's browsing data. Data reduction and reduction in computing costs, particularly in a cloud environment, are very important. Use of the DTS 214 does not result in significant reduction in accuracy of results relative to using raw data.

The DTS 214 takes as an input a vector of 30 numerical values, with a respective numerical value for each respective topic. The sum of the numerical values is 1, because the value is a percentage at which that device's traffic represents any one of those 30 topics. The DTS 214 can be used to characterize a specific device. Two devices might have similar traffic, if their users both watch sports and news and drama programs (referring to direct broadcast television viewership, for example). However, one user might watch more news than sports and another user might watch more sports than news. Therefore, the specific order in which those topics are ranked will affect the DTS 214. The numerical representations of the DTS 214 can be used by a data processing system for purposes of audience expansion or audience classification and other purposes.

For example, the data processing system may be given a seed segment of, for example, users intending to purchase an automobile. The DTS for all such users may be aggregated across the group to produce a group DTS. The data processing system may operate to determine the relative similarity between the DTS for a specific device and the DTS for the group having the particular interest, such as intent to purchase a new automobile. The result will be a probability score indicating how similar the DTS for the specific device is to the aggregate DTS for the group. This may be used, for example, for audience expansion. In an embodiment, all DTS results for a group of potential expanded audience members is compared with the group DTS of those intending to purchase an automobile. The group of users associated with devices having the top set of DTS probabilities may be used to expand the audience.

The DTS 214 can be used to improve the identity resolution of a device in a network by establishing a relationship between devices and people within a household. For example, a household may include multiple devices used by multiple human users. These can include mobile devices and devices for accessing content such television programming. The devices can access networks of a network provider or a content provider, or both. A model can be trained on first party data of the network provider or the content provider, or both. The ground truth set are two or more devices that are deterministically matched by the mobility data of the network provider or the content provider, or both. From this ground truth, a model may be constructed that predicts the probability of two devices belonging to the same person based on similarity of the DTS for each respective person. The following sections describe the similarities and feature engineering for the model.

Similarity Evaluation

With respect to evaluating similarities between two devices, there are several different similarity measures that are used to build the DTS device linking model. Three similarity measures may be classified as vector similarity measures. Two similarity measures may be classified as rank similarity measures, discussed in the following sections.

DTS Vector Similarity

Comparing two DTS may include using a similarity metric that quantifies the difference between the vector representations. Three different similarity metrics have been evaluated that quantify the similarity between two topic distribution vectors. The similarity is a value between 0 (no similarity) and 1 (identical). The three-similarity metrics considered were: 1. Cosine similarity, 2. Euclidean distance similarity, 3. L1 Similarity, and 4. Canberra distance similarity and are defined below.

Cosine similarity may be defined according to the following relation:

$$Cosine Similarity ( \vec{a} , \vec{b} ) = \frac{\vec{a} \cdot \vec{b}}{\vert a \vert * \vert \vec{b} \vert}$$

Euclidean similarity may be defined according to the following relation:

$$Euclidean Similarity ( \vec{a} , \vec{b} ) = 1 - \frac{{\vert \vec{a} - \vec{b} \vert}_{2}}{\sqrt{2}}$$

L1 similarity may be defined according to the following relation:

$$L 1 Similarity ( \vec{a} , \vec{b} ) = 1 - \frac{{\vert \vec{a} - \vec{b} \vert}_{1}}{2}$$

L1 similarity may be defined according to the following relation:

$$Canberra Similarity ( \vec{a} , \vec{b} ) = 1 - \frac{{\vert \vec{a} - \vec{b} \vert}_{1}}{{\vert \vec{a} \vert}_{{1}^{+}} {\vert \vec{b} \vert}_{1}}$$

In these relations, “●” is the vector dot product, ∥₂ is the L² vector norm, and ∥₁ is the L¹ vector norm. Initially, four distinct similarity values were intended, but because of the nature of the DTS vector, the L1 similarity and Canberra similarity are mathematically equivalent. Therefore, there are only three distinct DTS vector similarities that are computed.

DTS Rank Similarities

From one perspective, a DTS is a vector of values between 0 and 1 that sum to 1. A different perspective of a DTS is looking at the rank of the indexes, ordered by their values. The first step is to take their topic values and sort them in descending order. Then, take the sorted index of the top N values. In one example based on a household version of the DTS using broadcast satellite television viewership data, N was found to be 7 since the total permutations that exists leveled off, signifying decreased variance across DTS and no additional combinations beyond 9. Two additional similarity measure are computed based on the DTS vector rankings, as described below.

DTS Position Similarity (Overlap):

DTS position similarity is the traditional overlap similarity where, if the value at each index between vectors are equal, then the value is 1; otherwise, the value is 0.

$$\vec{p} = f \text{:} A \to B \{ \begin{matrix}1 & if {x}_{i} = {y}_{i} \\ 0 & otherwise\end{matrix} \}$$

$$( A , B ) = \frac{\sum \vec{p}}{n}$$

$$A = a set of n values$$

$$B = a set of n values$$

$${x}_{i} ∈ A$$

$${y}_{i} ∈ B$$

DTS Contains Similarity (Intersection):

DTS contains similarity is the number of values in that are common between the two DTS vectors normalized by the size of the vector.

$$C ( A , B ) = \frac{\vert A ⋂ B \vert}{n}$$

Feature Engineering

The data set for the device linking is constructed from the output from the DTS creation in the form of a dataframe with device identifier MacDevID and DTS vector as columns. Next, the identity graph from the deterministic linking of household, devices, and persons is formed. For each household, the feature sets contain all the pair-wise combinations of devices from the MSP data set which results in two MacDeviceIDS and two DTS vectors. The target variable is a binary variable where a value of 1 indicates that the two devices are linked to the same person and a value of 0 indicates the two devices are not linked to a single individual.

The features for the model are the five similarity measures between all the pairwise DTS vectors:

Cosine

Euclidean

Canberra

Rank Position

Rank Contains

Model

FIG. 2D illustrates an exemplary embodiment of a model 230 for the DTS in accordance with various aspects described herein. The model 230 includes a first level, level 0 model 232 and a second level, level 1 model 234. There are two sets of training data sets, class 0 training sets 236 and class 1 training sets 238. The model 230 is developed in a stacking framework with the two levels. The level 0 model 232 in the exemplary embodiment consists of the following four models:

Logistic Regression

Random Forest

Multi-Layer Perceptron

Gradient Boosted Decision Tree

The Level 1 generalizer model 234 in the exemplary embodiment is a random forest model and all the predictions from the Level 0 model 232 are used as input features. The final output is a probability that the two devices are linked. This trained model can then be applied to other devices in the household or other establishment or organization that have a DTS but are not part of the network provider's first party and a probabilistic linking in the overall identity graph.

FIG. 2E depicts an illustrative embodiment of a method 240 in accordance with various aspects described herein. The method 240 is an exemplary embodiment for developing a device topological signature (DTS) from data for a device and using the DTS subsequently.

At step 242, data is collected for one or more devices. In an example embodiment, browsing data for one or more mobile device or devices is collected. Such devices may include mobile telephones, tablet computers and other devices capable of accessing a radio network such as a mobile network of a mobile network service provider. The data may include browsing data generated when the device accesses one or more networks including the internet for information. In an example, the collected data includes a Mobile Station International Subscriber Directory Number or MSISDN for the device, a uniform resource locator (URL) or other network identifier for a network location accessed by the device, timestamp information, IAB tier 1 and tier 2 identification information and identification information for the mobile network service provider. The data corresponds to event data related to an event such as browsing a particular web site by the mobile device.

At step 244, the input data collected at step 242 is processed to remove certain information. For example, browsing data contains a large quantity of machine-related traffic that should be filtered out to arrive at human-initiated browsing activity. Other extraneous information, such as punctuation, may be removed as well.

At step 244, the base URL domain is determined. This information relates to the network location accessed by the device as the device browses the network. The base URL is included in a data string representative of the browsing data.

At step 248, the data is further processed to standardize the data. For example, the data may be tokenized and lemmatized to reduce the words of the browsing data to a canonical format. Other processing may be performed as well and the data is prepared into a final word representation of the event data.

At step 250, a device corpus for the browsing data for the device is obtained. In an example, this is done by dropping events with invalid device identifiers and by then grouping by device identifier and concatenating all the event strings together. The results is that each device has a browsing document and these browsing documents together form the device corpus. At step 252, the documents are vectorized, meaning they are converted to a vector format. Various techniques for vectorization are known and may be used. The vectors are weighted according to an inverse document frequency.

At step 254, an unsupervised latent Dirichlet allocation clustering algorithm (LDA) model is trained using the vectorized device corpus. In an example, thirty topics are chosen, but other numbers of topics may be selected and used based on the actual data and computational resources available. If additional predictive accuracy is required, and if suitable computational resources including memory space and processor time are available, other numbers of topics may be selected for the LDA model. At step 256, the LDA model is applied to each device document. At step 258, the result is a device topological signature (DTS) defined by a topic distribution vector in the 30 topics.

Subsequently, the DTS can be used, for example, for identity resolution and device linking. This can be done, for example, by establishing relationships between devices and people within a household. The LDA model can be trained as shown in FIG. 2E on the mobile network operator's first party data, where the ground truth set are two or more devices that are deterministically matched by the mobile network operator's mobility data. From this ground truth, a model is constructed that predicts the probability of two devices belonging to the same person based on the DTS similarity.

In step 260, browsing data is applied to the DTS and used to determine additional information about the device or user associated with the browser. In some examples, one or more machine learning models may be built using the DTS to discover links between devices with similar DTS. In one example, step 262, a cross-device relationship is resolved. That is, the owner of a first device associated with the DTS may be identified as the owner or user of a second device. In a second example, step 264, a new audience segment may be identified by identify the user of the device associated with the DTS and associating that user with other users having similar interests as reflected in their browsing history. The browsing history is reflected in the DTS for each user's devices. In a third example, step 266, an audience may be expanded using the DTS. Again, the DTS represents a fingerprint of a user of a device or a compressed version of the user's browsing history and interests. Those interests may be matched with other users with similar interests, using the various users' DTS as the source of comparison. Because the DTS in effect compresses much information about a user into a model form based on 30 topics, the DTS allows rapid comparison of user interests using minimal computational resources. Other exemplary uses may be made of the DTS as well.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

The device topological signature has particular application when collecting online browsing activity and other internet traffic. A network service provider or content provider may have access to household content viewership information. Such information relates to viewing content such as television, films and others on home devices such as a set top box (STB), digital video recorder (DVR), laptop and other computers, and via a home gateway that are all associated with a household or other premises. Such viewership information relates to networks and television programming and movies, instead of internet traffic. Typically, a household has multiple devices, including one or more STBs, one or more DVRs, one or more laptop and other computers, etc. Viewership information may include information about viewing of television content received at one or more of a set-top box, a satellite receiver and a network-connected computing device such as a laptop or desk top computer accessing content over the internet or other network. In the same way that internet traffic for a device provided a signal permitting identification of the device through the device topological signature, household content viewership information similarly provides a signal permitting identification of a household associated with the viewership information. Generally, such viewership information is aggregated at the household level. In some cases, if viewership data may be associated with respective devices in a household (for example, the living room STB, the laptop in the home office), the viewership information may enable development of a device topological signature for each device in the household.

FIG. 2F is a block diagram illustrating an example, non-limiting embodiment of a system 270 functioning within the communication network of FIG. 1 in accordance with various aspects described herein. The system 270 may be used for identification resolution of a household of television viewers. A household is intended to generally include any premises or arrangement or organization that shares access to television viewing, including through one or more common accounts with a service provider, content provider or network operator. A household may receiving content including television over a satellite television service, a cable television service, linear television (TV) service, data-driven linear TV service, addressable TV service, connected TV service, over-the-top (OTT) networks, web portals, and so on. In an exemplary embodiment, a household includes a family's home and the family includes one or more family members that access television services within the home either together or alone. The access may be by means of any appropriate technology, such as a television receiver a set-top box (STB), a cable modem, a wireless router, radio access network, etc. In general, any of the aspects of the communication network 100 of FIG. 1 may be used to access television programming, including broadband access 110, wireless access 120, voice access 130, media access 140 and access to content sources 175 for distribution of content including television programming to any or all of the access technologies.

In accordance with various aspects described herein, a household topological fingerprint (HTF) may be developed and used in conjunction with household viewership information. In embodiments, the HTF is the vector classification of the television viewing patterns recorded for a household across the topics from an unsupervised latent Dirichlet allocation (LDA) clustering model. The HTF contains a compact representation of the television viewing patterns of the household held in television viewership datasets. Such datasets may record viewership information such as programs or content items viewed, show name, episode name, episode description, show genre, viewing timestamp, duration of viewing, channel or network of viewing and advertisements viewed, along with channel change or network change information recorded as a viewer consumes various content at various devices in a household. That information becomes the corpus of words for the HTF.

This HTF data is then used to build machine learning models to discover links between households with similar HTFs and a measure of the strength of that similarity. The HTF data may also be used as a feature for other machine learning models for segmentation, audience expansion or to predict demographic, econographic, or psychographic information for the device user. The HTF provides an ability to quickly classify households based on behaviors exhibited in television viewing habits. These behaviors, once interpreted, are a precursor to lifestyle segmentation and for enhanced targeting based on hedonic consumption.

The HTF is based on and formed from television viewership information and may be used to inform both tune-in and targeted television advertising. Tune-in advertising includes television advertising for television programming. The HTF provides information about who watches what kinds of television. The HTF can then be used to find a great many more things about those households. The HTF can be further used to infer the size of the household, such as the number of persons living in a premises. One benefit of development and use of HTF is classifying people and classifying households in a variety of different way. With classification about the kinds of people that watch particular kinds of television programs, the classification can be used to determine how to target a collection of households. The HTF can be part of a viewership profile for a household, including information about what the members of the household like to watch or are likely to watch.

The system 270 of FIG. 2F is adapted for developing an HTF for a household. The household may include a variety of user devices, including a mobile device of a user such as mobile device 124 (FIG. 1), including a mobile phone, a tablet or other device. In some examples, the device may be laptop or other computer of a user. The system 270 in the exemplary embodiment includes a data cleansing module 272, a document vectorization module 274, and an LDA model 276. Other embodiments may include other components as well, or alternative components. The system 270 may be implemented on any suitable data processing system including a personal computer, set top box, internet gateway, or other source or channel of data. Also, the system 270 may be implemented on a separate device such as a server or other data processing system with access to data viewed by, received by or communicated from a device for which the HTF is desired.

The data cleansing module 272 and the document vectorization module 274 form a preprocessing module for preprocessing the input data 278. Preprocessing the input data 278 includes removing irregular data and formatting data into a standardized format. The data cleansing module 272 receives input data 278. In one example, the input data 278 includes viewership data based on events occurring at a STB for a satellite television network. In another example, the input data 278 includes viewership data from monitoring devices such as smart TVs where the viewer selects video on demand programming directly to the smart TV. If other network devices are available, including a residential gateway or one or more STBs for other networks, the input data 278 may include some or all viewership data for such networks. As other networks and distribution techniques are added in the future, input data 278 may be expanded to include viewership data for such networks.

In exemplary embodiments, customer consent 280 is obtained from customers before data is collected from a customer's household. Obtaining customer consent ensures that a customer's privacy is maintained. Further, input data 278 may be anonymized or filtered to ensure customer privacy. Other privacy protection steps may be taken as well.

The input data 278 generally includes third party viewership data. Generally, the input data 278 includes contains each TV channel switching event for television viewing within the household. In an example, the data of interest for each channel switching event is a group of text strings or text values. These may include, in an example, ban; zip, referring to the postal code for the area where the household is located; device_id, referring to a unique device identifier for the device on which television programming is consumed; device_type, referring to a manufacturer make and model for the device on which television programming is consumed; program_genre, referring to the genre of the television programming consumed; channel_long_name, referring to the identifier for the channel, the network or other source for the television programming consumed; program_title, referring to the title of the program consumed; episode_title, referring to a title of an episode of the program consumed; event_start_time_local, referring to the time at which the programming consumed began; event_end_time_local, referring to the time at which the programming consumed ended; program_watch_duration, referring to the time during which the programming was consumed; is_early_prime, referring to a time block during the day when the programing was consumed; is_late_prime, referring to a time block during the day when the programing was consumed. In the example, each time a user selects or switches a channel to view a program, an event or channel-switching event is recorded, along with the noted data fields. The input data 278 may include other data in addition to these data items or instead of these listed data items. For example for different types of television service, such as satellite television service or OTT television service, other input data may be collected and be received as input data 278. In an example, input data 278 processed by the data cleansing module 272 is on the order of 1.2 billion viewing events.

In the data cleansing module 272, the television event viewership information of the input data 278 is cleaned to remove unwanted data, irregular data, incomplete data or other data that may be of limited use in subsequent operations. In one example, the following operations are performed. First, events not during prime time are removed. In an example, prime time is defined as 8:00 PM to 11:00 PM. Second, events with invalid device identifiers are removed. Third, only programs that are watched for five minutes or longer are included. Any other threshold time duration for viewing time by a user may be used, such as 15 minutes, one hour, etc. Other data cleansing operations may be performed as well.

After these filtering operations by the data cleansing module 272, the document vectorization module 274 concatenates together the terms for the remaining valid events. These include in an example program_genre, channel_long name, program_title, and episode_title. Next, in the document vectorization module 274, punctuation, stray characters, and stop words are removed. Further, the string of words is tokenized and lemmatized into the final word representation of the event data.

A device corpus is obtained by the document vectorization module 274 through grouping by device identifier and concatenating all the event strings together, so each device in the household has a viewing document. Each viewing document forms a record of content viewership using the device. These documents together form the device corpus. In an embodiment, the documents are vectorized with Spark's native CountVectorizer or another vectorizing tool. Further, the documents are weighted with inverse document frequency (IDF) count.

The device-level LDA model 276 receives the entire device vectorized corpus from the document vectorization module 274. The device-level LDA model 276 is trained on the entire device vectorized corpus using thirty topics, in an example. As discussed above in conjunction with FIGS. 2A and 2B, any suitable number of topics may be used in conjunction with the LDA model 276. The number of topics may be specified by a user. The number of topics used for the LDA model 276 may be specified based on the available data processing infrastructure, including processors and memory, and the precision required, as well as the data processing time available. For example, the perplexity curve illustrated in FIG. 2B may inform the choice of a number of topics to use in the LDA model 276. The household corpus 282 is obtained by concatenating the documents for all devices belonging to each household. The trained LDA model 276 is applied to each device document to arrive at the household topological fingerprint (HTF) 284. Each household is characterized by a unique topic distribution vector 286 specifying thirty topics and vector values for each.

The HTF 284 is a compact representation of human television viewing activity. The HTF 284 is a vector of dimension thirty in a normed vector space and the thirty topics from the LDA training are a basis for this vector space. If another number of topics is used for training the LDA model, the dimension of the HTF 284 will vary. The HTF 284 allows for efficient determination of distance and similarity measures. This benefits segmentation and machine learning models by providing a feature with well-behaved and strictly numeric properties.

FIG. 2G is a block diagram of an exemplary inference trait model pipeline 290 in accordance with various aspects described herein. The HTF 284 developed by the system 270 of FIG. 2F may be used as a feature to predict Experian household demographic, psychographic, or econographic inferences provided by Experian plc. Experian plc collects data on consumers and households and makes that data available for a variety of business purposes, including audience targeting. The data includes demographic information such as age, gender, marital status, presence of children in the household, etc. The inference trait model pipeline 290 illustrates a system and method for building a machine learning model to use HTF 284 predict household classification information that Experian data would provide.

The pipeline 290 includes in this example input data sources 291, 292, preprocessing including data manipulation module 293 and a class manipulation module 294, a machine learning model module 295 and a household composition inference module 296. The input data to the pipeline 290 includes HTF topic distribution as an input data source 291. The HTF topic distribution may be in any suitable format, such as the HTF 284 developed by the system 270 of FIG. 2F.

The input data to the pipeline 290 further includes Experian inferences from input data source 292 which relate to a household's demographic, psychographic, or econographic behavior based on data collected by Experian plc. Some examples of Experian household traits include size of a household, age range and gender of members in a household, ethnicity, occupational complexity, “BUY AMERICAN”, etc. Different inferences have different possible classes, for example, for the “BUY AMERICAN” inference, the possible values are EXTREMELY LIKELY, HIGHLY LIKELY, VERY LIKELY, SOMEWHAT LIKELY, VERY UNLIKELY, LIKELY, EXTREMELY UNLIKELY, SOMEWHAT UNLIKELY, HIGHLY UNLIKELY. The input data sources 291, 292 may be supplemented or modified in any suitable manner.

Data from the input data sources 291, 292 is preprocessed. In the data manipulation module 293, the latest or most recent Experian inference data is extracted from the data received from the input source 292. Experian updates the possible values for inferences periodically and there can be a time window difference between Experian records and when household viewership or users' browser activity data were collected to develop the HTF for the HTF topic distribution of the input data source 291. To mitigate this time difference, the Experian data from the input data source 292 are limited to match the time on which TV viewership and user browser activity were collected for form the HTF topic distribution of the input data source 291.

Further preprocessing occurs in the class manipulation module 294. The Experian data may exhibit an extreme data imbalance. That is, there is a huge difference between class representations within the data set. Therefore, to create a well-balanced class distribution within the training data set, class aggregation and down sampling may be performed on the training data set in the class manipulation module 294. As illustrated in FIG. 2G, this may include steps of class encoding and aggregation, class proportion validation and class balancing. Also, to enhance the machine learning model's ability to better represent HTF, a feature engineering procedure may be performed which includes driving the maximum, minimum, range, average, and standard deviation of the topical-weight vector. During model training, these statistics (or additional feature set) are provided to the model along with the original HTF.

The machine learning model module 295 may use any of a variety of machine learning models or a combination of such models. For model training and validation, the entire data set was divided into a training set (70%) and a testing (30%) set. For the classification problem, three types of models were employed. These included a Random Forest model, a Multinomial Logistic Regression model, and a Multilayer Perceptron from a library of machine learning models known as the Apache Spark MLLib library. To improve the overall classification accuracy, a technique called Stacking was employed that uses a new model to find the best ensemble predictions from multiple models. In an embodiment, the final reported key performance indicators the machine learning model module 295 are from the Stacking model that combined predictions from the Random Forest and Multinomial Logistic Regression models.

The household composition inference module 296 receives the output of the machine learning model module 295 and produces inferences about the composition of a household corresponding to the HTF 284 the input data source 291. The inferences may include lifestyle and interests for members of the household and other information. In one evaluation, the overall performance of the model was considered satisfactory. The average classification accuracy was around 60% for most inferences. Class aggregation and balancing steps were considered to be important in boosting the classifier's performance as these steps reduced the size of class set and hence simplified the complexity of the problem. This is evident from the fact that the models showed low performance for more than two class inferences, but perform relatively better for binary inferences. Furthermore, the Stacking technique helped boost model performance by 3%-7%.

The HTF 284 can be used in a variety of ways. In a first example, the HTF 284 is used to resolve cross-device relationships. A network operator or content provider or advertiser may have information about content viewed on a variety of devices associated with a single household. This may include mobile devices such as device 124 (FIG. 1) and stationary devices in a household such as televisions, set-top boxes, computers and other devices. However, it is more difficult to know which individual user in the household is using a particular device and to associate the usage with both the device and the user in the household. A household of even just two individuals may include three or more computers, three or more mobile telephones, and two or more tablet computers, and so forth. Further, such a household may have three or more television sets plus a home gateway, a digital video recorder (DVR) and other devices as well. If a network operator or content provider or advertiser wants to target one particular individual of the household, the individual who is using each device should be identified. Being able to associate individual users with respective devices, and the content the users consume, has the highest value to parties such as the network operator, the content provider and the advertiser. The HTF 284 may be used to identify a household and, in turn, particular users in the household, based on the content items viewed on the devices. For example, an advertising campaign is running on individual set-top boxes, marketed to a specific seed set of viewers. The seed set of viewers is chosen to receive the marketing in order to stimulate the market and encourage faster adoption of a product. The specific seed set and the devices in the household can be classified as additional devices in the household. By identifying cross-device relationships, the seed set can be expanded to mobile devices associated with the household or individual members of the household. This is referred to as cross-device audience expansion. Compared to mobile devices, there are fewer set-top boxes in a market.

In a second example, the HTF 284 may be to facilitate audience expansion. If a network operator or content provider has a substantial amount of data on content viewers on home devices in a household, that network operator or content provider may create look-alike audience models based on the existing users. For example, the operator may have a relatively large amount of viewership data on a relatively few number of people who view content. If an advertiser wishes to target users based on properties such as demographics or interests, the advertiser can specify one or more audience segments having those characteristics. However, the targeted segments may be too narrow, for example, and have relatively few users as members of the target segments. An option is to use look-alike audience modelling to identify or create a segment that includes users similar to users in a given user segment. Because of the volume of user data, the look-alike models may be very granular in nature, meaning they are focused on very narrow interests or preferences of viewers. The HTF 284 enables determining a look-alike model of a television audience in a substantially reduced amount of time, using substantially reduced computer resources. The HTF 284 is a representation of all of a household's content viewing, based on the viewership data collected for the household. Therefore, using the 30 topics with the HTF 284, a look-alike model may be developed in, for example, 20-30 minutes of processing time in contrast with 20-30 hours of processing time to identify a look-alike model using all of the household's viewership data. Data reduction and reduction in computing costs, particularly in a cloud environment, are very important. Use of the HTF 284 does not result in significant reduction in accuracy of results relative to using raw data.

In a third example, the HTF 284 may be to facilitate creating a new audience segment. In television viewing and other content presentation, segments are individuals or groups within a population that have some common interest or feature that suggests they should be combined in a group to, for example, receive the same television programming or advertising. Other people have related interests that may be matched with the interests of individuals based on HTF 284. The HTF 284 can be used to detect those interests among viewers in a household. Subsequently, the household associated with the HTF 284 may be included in an audience segment based on a particular viewer interest and that audience segment may be used for targeting advertising or content. That is, if an advertiser or content provider wishes to display advertising or other content to viewers in the segment, the advertiser or content provider can specify that segment and the advertising or content will be provided to one or more of the devices associated with the viewer in the household.

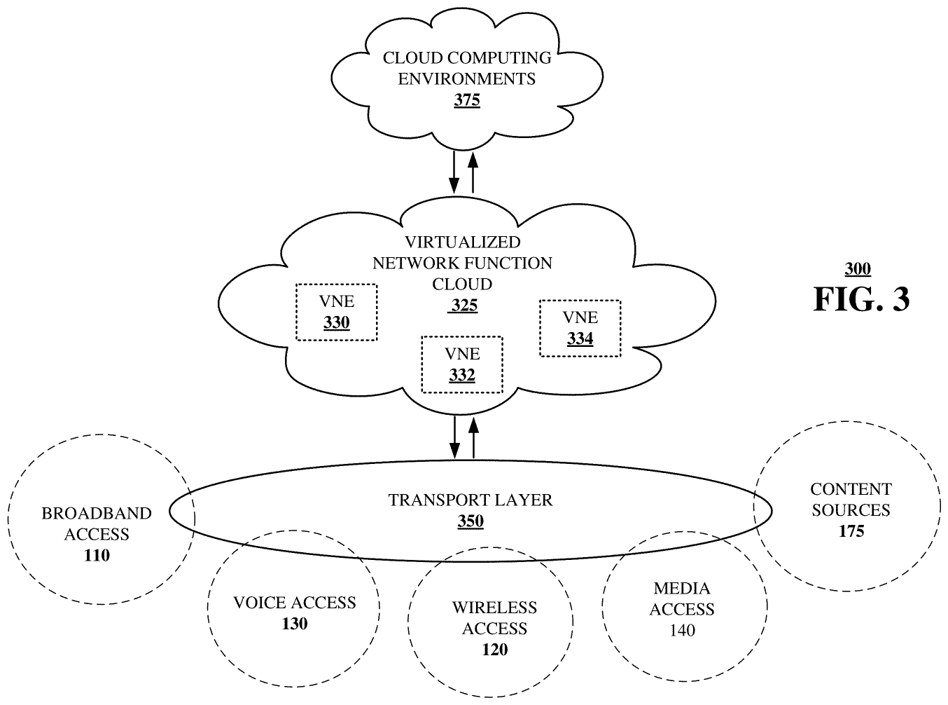

Referring now to FIG. 3, a block diagram is shown illustrating an example, non-limiting embodiment of a virtualized communication network 300 in accordance with various aspects described herein. In particular a virtualized communication network 300 is presented that can be used to implement some or all of the subsystems and functions of system 100, the subsystems and functions of system 200, and method 270 presented in FIGS. 1, 2A through 2G and 3. For example, virtualized communication network 300 can facilitate in whole or in part receiving content viewership data for content items viewed by members of a household, developing a household topological fingerprint for the household, and using the household topological fingerprint to provide additional content items including advertising to the household.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

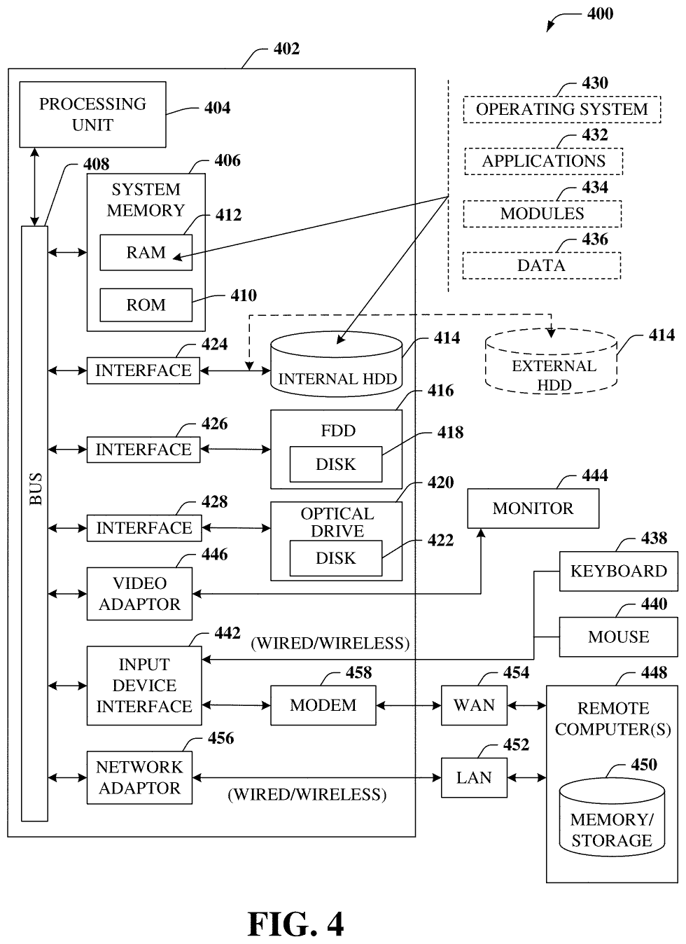

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part receiving content viewership data for content items viewed by members of a household, developing a household topological fingerprint for the household, and using the household topological fingerprint to provide additional content items including advertising to the household.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

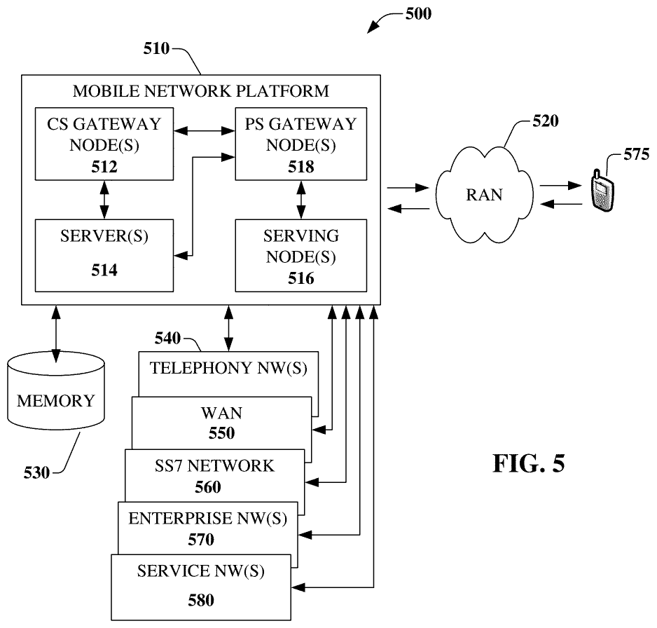

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part receiving content viewership data for content items viewed by members of a household, developing a household topological fingerprint for the household, and using the household topological fingerprint to provide additional content items including advertising to the household. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

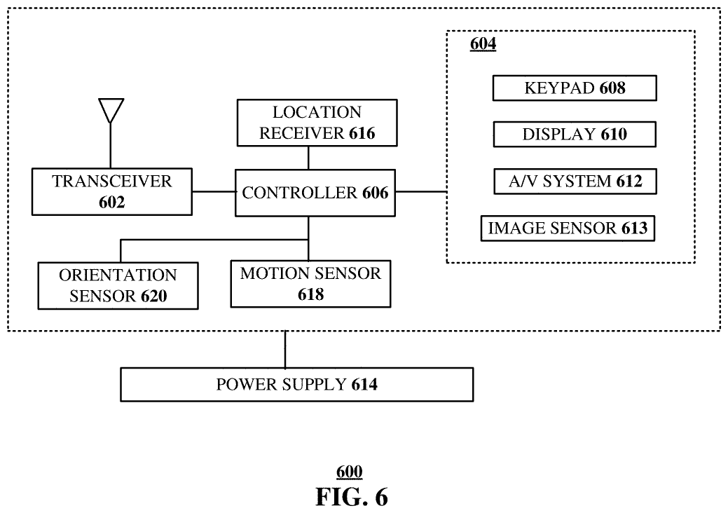

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part receiving content viewership data for content items viewed by members of a household, developing a household topological fingerprint for the household, and using the household topological fingerprint to provide additional content items including advertising to the household.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
receiving, by a processing system including a processor, viewership data for a plurality of devices associated with a household, the devices for viewing content items received over a network from a network provider at the household;
concatenating, by the processing system, respective viewership data for respective devices of the plurality of devices, forming respective device documents;
vectorizing, by the processing system, the respective device documents to form vectorized device documents;
concatenating, by the processing system, the vectorized device documents to form a household corpus of viewership data for the household;
training, by the processing system, a clustering model on the household corpus of viewership data to form a household topological fingerprint (HTF) for the household, the HTF forming a vector classification of viewership patterns for the household; and
selecting, by the processing system, content items for the household based on the HTF.

2. The method of claim 1, further comprising:
identifying, by the processing system, another household having a similar HTF to the HTF for the household; and
associating, by the processing system, the household and the other household based on similarity.

3. The method of claim 1, wherein the receiving viewership data for a plurality of devices associated with a household comprises:
receiving, by the processing system, information about viewing of television content received at one or more of a set-top box, a satellite receiver and a network- connected computing device.

4. The method of claim 3, wherein the concatenating respective viewership data for respective devices comprises:
concatenating, by the processing system, for each respective device, one or more of a program genre, a channel name, a program title and an episode title for each viewed content item of the respective viewership data.

5. The method of claim 4, further comprising:
cleansing, by the processing system, respective viewership data, forming cleansed viewership data; and
wherein the concatenating respective viewership data comprises concatenating the cleansed viewership data.

6. The method of claim 5, wherein the cleansing respective viewership data comprises:
removing, by the processing system, viewership data corresponding to events occurring outside prime time;
removing, by the processing system, viewership data with invalid device identifiers; and
removing, by the processing system, viewership data having a viewing time less than a threshold time duration.

7. The method of claim 1, wherein the selecting, by the processing system, content items for the household based on the HTF comprises:
selecting, by the processing system, advertising content based on the HTF; and
providing, by the processing system, over a data communication network, the advertising content to the household.

8. The method of claim 1, further comprising:
combining, by the processing system, the household in an audience segment with other households, wherein the combining is based on the HTF; and
providing, by the processing system, advertising data defining advertisements over a data network to households, including the household, in the audience segment.

9. The method of claim 8, further comprising:
determining, by the processing system, audience interests of the audience segment based on at least the HTF; and
selecting advertisements based on the audience interests.

10. The method of claim 1, wherein training a clustering model comprises training, by the processing system, an unsupervised latent Dirichlet allocation (LDA) clustering.

11. A device, comprising:
a processing system including a processor; and
a memory that stores executable instructions that, when executed by the processing system, facilitate performance of operations, the operations comprising:
receiving content viewership data for content items viewed by members of a household;
filtering the content viewership data to remove irregular data, forming filtered viewership data;
combining the filtered viewership data for respective viewing devices of the household according to respective device identifiers of the respective viewing devices, forming device documents;
combining the device documents for the respective viewing devices of the household to form a household corpus of viewership data for the household;
training a clustering mode on the household corpus of viewership data, forming a household topological fingerprint (HTF) for the household, the HTF forming a vector classification of viewership patterns for the household;
associating respective members of the household with the respective viewing devices of the household; and
selecting content items for the respective members of the household based on the HTF.

12. The device of claim 11, wherein the filtering the content viewership data comprises:
removing content viewership data corresponding to events occurring outside prime time;
removing content viewership data having an invalid device identifier; and
removing content viewership data having a viewing time less than a threshold time duration.

13. The device of claim 11, wherein the operations further comprise:
combining the household in an audience segment with other households, wherein the combining is based on the HTF; and
providing advertising data defining advertisements over a data network to households, including the household, associated with the audience segment.

14. The device of claim 13, wherein the combining the household in an audience segment with other households further comprises:
identifying another household having a similar HTF to the HTF for the household; and
associating the household and the other household in the audience segment based on similarity.

15. The device of claim 11, wherein the receiving content viewership data comprises:
receiving information about viewing of television content received over a cable television network at a set-top box of the household;
receiving information about viewing of television content received over a satellite television receiver of the household; and
receiving information about viewing of television content received over a data communication network at a computing device of the household, or a combination of any of these.

16. The device of claim 11, wherein the operations further comprise:
vectorizing the device documents to form vectorized device documents.
combining the vectorized device documents to form the household corpus of viewership data for the household.

17. A non-transitory, machine-readable medium, comprising executable instructions that, when executed by a processing system including a processor, facilitate performance of operations, the operations comprising:
receiving television viewership data for content items viewed by members of a household, the television viewership data including text string information;
filtering the television viewership data to remove irregular data, forming filtered television viewership data;
concatenating text string information of the filtered television viewership data, wherein the concatenating text string information is based on device identifiers associated with viewing devices of the household, forming device documents for respective device of the household;
concatenating the device documents, forming a household corpus of viewership data for the household;
forming a vector classification of viewership patterns for the household, wherein the forming the vector classification comprises training a clustering model on the household corpus of viewership data;
identifying the members of the household by applying a portion of the device documents to the clustering model; and
selecting content items for viewing by respective members of the household based on the identifying the members of the household and the vector classification.

18. The non-transitory, machine-readable medium of claim 17, wherein the selecting content items comprises selecting advertisements for viewing by the members of the household.

19. The non-transitory, machine-readable medium of claim 17, wherein the operations further comprise:
combining the household in an audience segment with other households, wherein the combining is based on the vector classification of viewership patterns; and
providing advertising data defining advertisements over a data network to households, including the household, included in the audience segment.

20. The non-transitory, machine-readable medium of claim 17, wherein the filtering the television viewership data comprises:
removing television viewership data corresponding to events occurring outside prime television viewing time;
removing television viewership data with invalid device identifiers; and
removing television viewership data having a viewing time less than a threshold time duration.
